(19) United States
(12) Patent Application Publication
(10) Pub. No.: US 2012/0147064 A1
(43) Pub. Date: Jun. 14, 2012

(54) DISPLAY APPARATUS

(75) Inventor: Fujio Kawano, Kawasaki-shi (JP)

(73) Assignee: CANON KABUSHIKI KAISHA, Tokyo (JP)

(21) Appl. No.: 13/313,763

(22) Filed: Dec. 7, 2011

(30) Foreign Application Priority Data
Dec. 13, 2010 (JP) 2010-277320

(51) Int. Cl. G09G 5/10

(52) U.S. Cl. 345/690

(57) ABSTRACT

A display apparatus includes light emitting elements, wherein when an input gray-scale signal is lower than a certain gray-scale level, a light emitting element is caused to emit light upon receiving a first brightness signal higher than a brightness given based on the input gray-scale signal and a second brightness signal lower than the brightness given based on the input gray-scale signal during a former and a latter half of a light-emission period, and wherein when the input gray-scale signal is higher than the certain gray-scale level, the light emitting element is caused to emit light upon receiving the third brightness signal corresponding to the brightness given based on the input gray-scale signal during the former and the latter half of the light-emission period.

### BACKGROUND OF THE INVENTION

1. Field of the Invention

The present invention relates to a display apparatus including light emitting elements that are arranged in matrix form, and a method of driving the display apparatus.

2. Description of the Related Art

A display apparatus includes a plurality of pixels arranged on a substrate in matrix form, where each of the pixels includes a light emitting element such as an organic EL element. Each of the pixels includes a driving circuit including a thin film transistor (TFT) and other circuit elements.

The TFT included in the driving circuit is made of amorphous silicon or polysilicon. The characteristics of the TFTs are nonuniform due to the manufacturing method. Particularly, since the polysilicon TFT is manufactured by polycrystallizing amorphous silicon through laser annealing, the characteristic thereof varies due to the nonuniformity of the laser-irradiation intensity. The above-described characteristic variations appear on a display-image screen as striped unevenness of brightness.

WO2005/101360 discloses an invention that eliminates uneven brightness caused in the manufacturing process by detecting the transistor characteristic of each pixel and correcting the data voltage.

Uniform TFT characteristics are obtained by repeatedly irradiating a given part of the substrate with laser beams during the laser-annealing operation to average the effects of the irradiation-intensity variations. However, repeating the laser irradiation increases the time consumed to perform the laser-irradiation operation for a single substrate, which increases costs. Further, providing a circuit for detecting the TFT characteristic and correcting the data voltage of each pixel particularly requires a memory for storing correction data and also increases the costs. Accordingly, a method of eliminating uneven brightness, which reduces the time consumed to perform the manufacturing operations and simplifies the configuration of a driving circuit, has been demanded.

### SUMMARY OF THE INVENTION

The present invention provides a display apparatus including a display unit having an array of light emitting elements, a driving unit that drives and causes the light emitting elements to emit light, and a signal processing unit that processes and transfers an input image signal to the driving unit, the signal processing unit including a comparison unit configured to compare a gray-scale signal included in the image signal to a certain gray-scale level and a conversion unit configured to convert the gray-scale signal into a brightness signal, wherein when the comparison unit outputs a result indicating that the gray-scale signal in the image signal is lower than the certain gray-scale level, the conversion unit generates a first brightness signal that gives a brightness higher than the brightness given based on the gray-scale signal and a second brightness signal that gives a brightness lower than the brightness given based on the gray-scale signal, and the driving unit causes the light emitting element to emit light in accordance with the first and second brightness signals during a former and a latter half of a light-emission period, and wherein when the comparison unit outputs a result indicating that the gray-scale signal in the image signal is higher than the certain gray-scale level, the conversion unit converts the gray-scale signal into a third brightness signal corresponding to a brightness given based on the gray-scale signal, and the driving unit causes the light emitting element to emit light in accordance with the third brightness signal during both of the former and the latter half of the light-emission period.

According to the present invention, light emitting elements emit light at two brightness levels for single gray-scale data. Accordingly, the gray-scale display is performed using a region where the current variation of transistors is small or insignificant without using a region where the current variation of the transistors is large, so that the uneven brightness of a display apparatus is reduced.

Further features of the present invention will become apparent from the following description of exemplary embodiments with reference to the attached drawings.

### BRIEF DESCRIPTION OF THE DRAWINGS

FIG. 1 is a graph illustrating different characteristics of two transistors.

FIG. 2 is a graph illustrating the brightness nonuniformity observed in striped unevenness.

FIG. 3 is a graph indicating the relationship between the visibility of the striped unevenness and brightness.

FIG. 4 is a block diagram illustrating an exemplary configuration of a display apparatus according to a first embodiment of the present invention.

FIG. 5 is a graph illustrating the relationship between an input gray-scale signal and a brightness signal according to the first embodiment.

FIG. 6 illustrates a driving circuit of an organic EL element according to the first embodiment.

FIG. 7 is a timing chart illustrating operation according to the first embodiment.

FIG. 8 is a graph illustrating the relationship between an input gray-scale signal and a brightness signal according to a comparative example.

FIG. 9 illustrates the time when data is written into/read from a memory according to the first embodiment.

FIG. 10 is a graph illustrating the relationship between an input gray-scale signal and a brightness signal according to a second embodiment of the present invention.

FIGS. 11A and 11B illustrate a light-emission sequence performed according to a third embodiment of the present invention.

FIGS. 12A and 12B illustrate a different light-emission sequence performed according to the third embodiment.

FIG. 13 schematically illustrates an operation for each subframe according to a fourth embodiment of the present invention.

FIG. 14 illustrates a driving circuit of an organic EL element according to the fourth embodiment.

FIGS. 15A and 15B are timing charts each illustrating an operation for a subframe according to the fourth embodiment.

### DESCRIPTION OF THE EMBODIMENTS

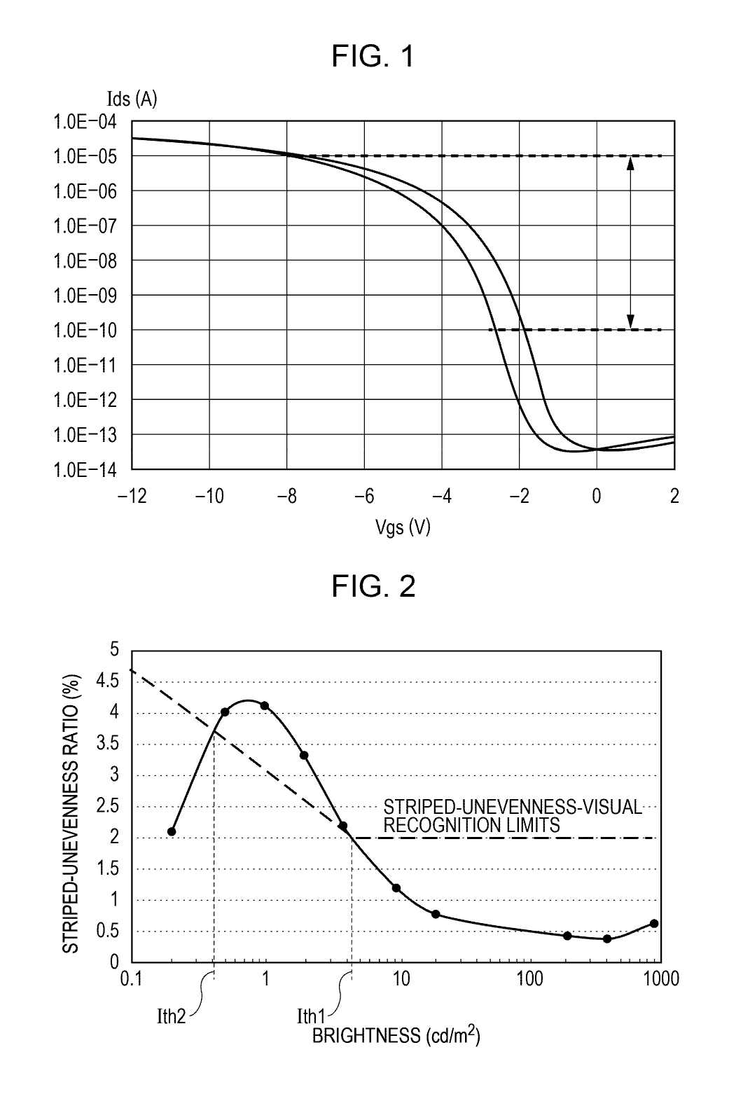

FIG. 1 illustrates the Vgs-Ids curves of two types of PMOS transistors with different threshold voltages and mobilities. The horizontal axis indicates a gate-source voltage (Vgs) and the vertical axis indicates a drain current (Ids). A double-headed arrow indicates a driving-current range when a display element is subjected to gray-scale driving with a current ratio of one hundred thousand to one. The variations of light emission are adjusted within a range of 100 pA to 10 μA, which is indicated by the double-headed arrow.

The absolute range of the drain current Ids is determined based on the brightness, contrast, and light-emission efficiency of a light emitting element driven by the drain current Ids. The absolute range may be adjusted based on the transistor size. When the same gate-source voltage Vgs is applied to the two transistors, with respect to a difference between drain currents Ids, the current ratio between two curves is small in a large current region (100 nA or more) and large in an intermediate current region (1 nA to 100 nA).

The ratio between drain currents is large in a smaller current region (1 nA or less). However, the absolute current value is significantly small and therefore, the current difference has a small value. In that current region, the light emitting elements are almost in a dark state, where difference in brightness is visually unrecognizable.

When the light emitting elements driven by the above-described transistors are arranged in matrix form and used as a display apparatus, variation in transistor characteristics that are shown in FIG. 1 appears as visible nonuniformity of brightness. FIG. 2 indicates the brightness nonuniformity occurring when the light emitting elements emit light based on a certain brightness signal.

The display apparatus includes thin film transistors (TFTs) manufactured through a low-temperature polysilicon (LTPS) process, and variations in transistor characteristics, which are caused during a laser annealing operation, are visually recognized as striped uneven brightness (hereinafter referred to as the striped unevenness) parallel to the laser-irradiation region direction (the vertical direction of a display area). The unevenness is viewed as linear stripes brighter than the surroundings when the entire image screen of the display apparatus is caused to emit light with a uniform gray-scale. The striped unevenness becomes noticeable when the brightness of the surroundings is low and becomes less noticeable when the brightness of the surroundings is relatively high.

FIG. 2 shows an amount indicating the contrast of brightness of the stripe to the surroundings defined by the following equation, depending on the brightness of the image screen:

striped-unevenness ratio (%)={(brightness of pixels in striped unevenness)−(average brightness of pixels around the striped unevenness)}/(the average brightness of pixels around the striped unevenness)×100

The average brightness of pixels around the striped unevenness is calculated as the average brightness of five pixels on either side of the striped unevenness.

Since the ratio of the drain currents Ids of the transistors with different characteristics varies depending on the current region as described above, the striped-unevenness ratio is changed in relation to the brightness as illustrated in FIG. 2. A broken line shown in FIG. 2 indicates the limits of the human visually recognizing the striped unevenness.

The striped-unevenness ratio is low and below the visual-recognition limits in the region corresponding to a high brightness of a few tens of cd/m² or more. As shown in FIG. 1, the current ratio between the two light emitting elements with different transistor characteristics is small in a region where the current of the transistor is large. This is the reason of the low striped unevenness ratio in a high brightness region illustrated in FIG. 2.

The striped-unevenness ratio is increased in an intermediate brightness region from around 10 cd/m² to 1 cd/m². At 4 cd/m² or below, the striped-unevenness ratio exceeds the visual-recognition limits and the striped unevenness becomes visible. Hereinafter, the brightness corresponding to the upper limit of the range where the striped unevenness is visible is referred to as a first threshold brightness Ith1. In FIG. 2, the first threshold brightness Ith1 is about 4 cd/m².

In the intermediate brightness region, the current ratio between two transistors with different characteristics is increased with a decrease in the drain current of the transistors. This is the reason of increasing of the striped-unevenness ratio with the decreased brightness in the region corresponding to a brightness of a few tens of cd/m² or less as shown in FIG. 2.

The striped-unevenness ratio is maximized near the brightness of 1 cd/m² and decreased again. In the region corresponding to a brightness of 1 cd/m² or less, the brightness difference between inside and outside of the striped unevenness is decreased because the absolute value of the current is small. When the value of the brightness is reduced to 0.4 cd/m² or less, the striped-unevenness ratio is reduced to the visual-recognition limits or less again, and the striped unevenness becomes invisible. The brightness corresponding to the lower limit of the range where the striped unevenness is visually recognizable is referred to as a second threshold brightness Ith2. In FIG. 2, the second threshold brightness Ith2 is about 0.4 cd/m².

The limits of the striped-unevenness visual recognition, indicated by the broken line shown in FIG. 2, are constant when the brightness is relatively high. When the brightness is low, the limit of visually recognizable striped unevenness tends to increase. However, since an actual striped-unevenness ratio exceeds the visual-recognition limits, the striped unevenness becomes visible in the intermediate brightness region. When the brightness is significantly low, the striped unevenness is too dark to be recognized.

FIG. 3 describes the above using a graph indicating the relationship between a gray-scale signal and brightness.

The horizontal axis in FIG. 3 indicates the voltage of an image signal. For 256-level gray scale, 256 values are provided on the horizontal axis. The vertical axis indicates the brightness corresponding to gray scale. Since the brightness of a light emitting element such as the organic EL element is almost proportional to a passing current, it may be considered that the vertical axis indicates a current passing through the light emitting element. The image signal may not necessarily be proportional to the brightness, and the relationship therebetween becomes nonlinear in accordance with the gamma characteristic of the display apparatus as shown in FIG. 3.

When a high gray-scale signal in a region indicated by the symbol (C) of the horizontal axis is input, the brightness exceeds the first threshold brightness Ith1. Therefore, even though the brightness varies due to the striped unevenness, the variations are not visually recognized.

When an intermediate gray-scale signal in a region indicated by the symbol (B) is input, the brightness falls within a region between the first threshold brightness Ith1 and the second threshold brightness Ith2, and the nonuniformity of the brightness is easily recognizable by the human eye and the striped unevenness becomes significant.

When an intermediate gray-scale signal in a low gray-scale region (A) is input, the brightness is further reduced and the nonuniformity is less recognizable, because the image screen is dark.

The upper and lower limits of the range of the intermediate gray-scale signal region (B) may be determined by conducting a test to determine whether or not the striped unevenness is visually recognized by many persons and calculating the average value of the test results.

The uneven brightness is significant in the low gray-scale region (A) and the intermediate gray-scale region (B), and is insignificant in the high gray-scale region (C). Using this property, the present invention proposes a display apparatus in which, upon receiving the signal in the lower gray-scale region, light emitting elements emit light with brightness higher than the brightness of the gray-scale signal in a part of a certain time period (a frame period in general) and with brightness lower than the brightness of the gray-scale signal in the remaining part of the certain time period. Upon receiving the signal in the higher gray-scale region, light emitting elements emit light with the brightness of the gray-scale signal over the certain time period. The apparent uneven brightness is thereby reduced.

Upon receiving the low gray-scale signal, two brightness signals, that is, a signal with brightness higher than that of the low gray-scale signal and that with brightness lower than that of the low gray-scale signal are generated. Then, the light emitting element is caused to emit light over two time periods based on the generated brightness signals, and a brightness obtained as a time average is caused to agree with the brightness of the original gray-scale signal. Since the light emitting element is caused to emit light with brightness higher than that of the input signal in one of the two time periods, the gray-scale range where the unevenness is visually recognizable becomes narrower than in the case where the light emitting element is caused to emit light with the brightness corresponding to the input signal in both the time periods.

Upon receiving the high gray-scale signal, the original gray-scale signal is directly used as a brightness signal, and the light emitting element is caused to emit light over two light-emission periods with the same brightness. If the light emitting element is caused to emit light two times with the high brightness and the low brightness, respectively, upon receiving the high gray-scale signal, the light emitted during one of the light-emission periods will have a low brightness and the unevenness becomes visible. However, the unevenness is reduced by causing the light emitting element to emit light two times with the same brightness.

Hereinafter, embodiments of the present invention will be described in detail. In the following description, a display apparatus including an organic EL element as the light emitting element will be exemplarily described. However, a display apparatus according to an embodiment of the present invention may be achieved without being limited thereto.

### First Embodiment

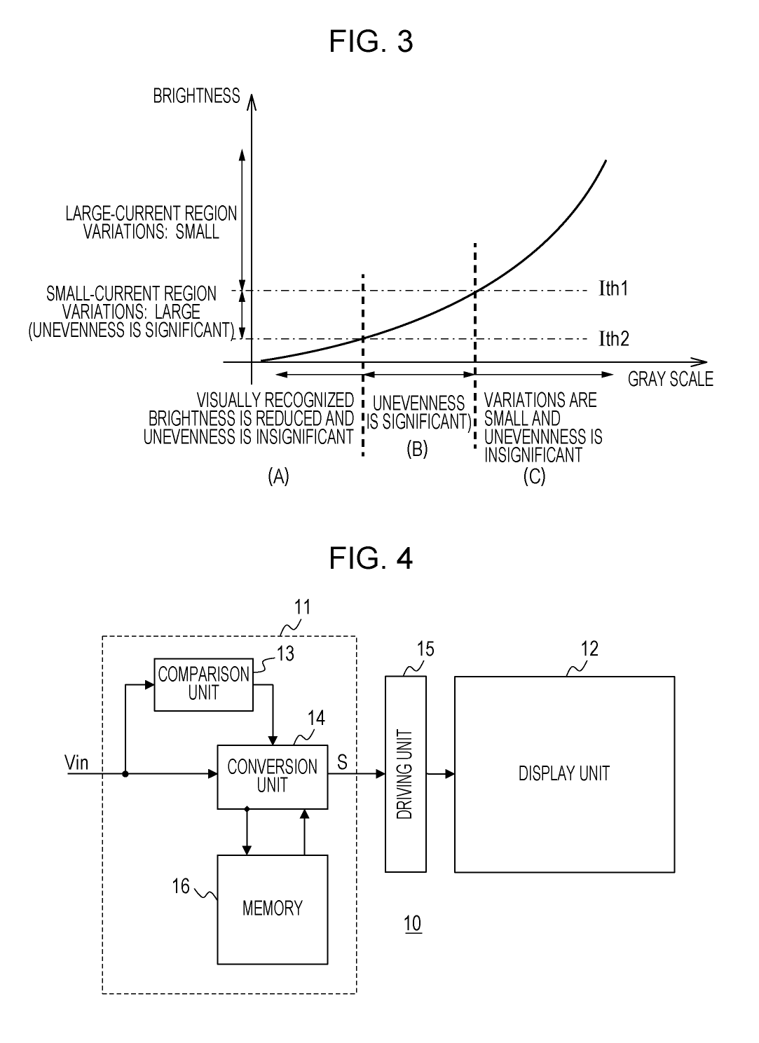

FIG. 4 is a block diagram illustrating an exemplary configuration of a display apparatus according to a first embodiment of the present invention.

A display apparatus 10 according to the first embodiment includes a display unit 12 configured to display data, a signal processing unit 11 configured to process an input image signal Vin, and a driving unit 15 configured to drive the display unit 12 based on the processed signal. The display unit 12 includes a plurality of organic EL elements provided as light emitting elements and a plurality of driving circuits including a MOSTFT, etc., which drives the organic EL elements. The organic EL elements and the driving circuits are arranged in matrix form.

The image signal Vin is a color-specific digital or analog gray-scale signal including the brightness information corresponding to each of the light emitting elements of the display unit 12. The image signal Vin is a time-series signal synchronized with a clock signal, and a 1-clock image signal corresponds to a single organic EL element. The image signal Vin for one frame corresponding to all of the light emitting elements of the display unit 12 is transmitted to the display apparatus 10 at intervals of 1/60 second.

The image signal Vin includes a gray-scale signal indicating the brightness of each of the organic EL elements of the display unit 12 (hereinafter, the gray-scale signal is not distinguished from the image signal and shown with the same symbol Vin). The signal processing unit 11 converts the gray-scale signal Vin into a brightness signal S. The brightness signal S is transferred to the display unit 12 via the driving unit 15 to cause a display element to emit light with the corresponding brightness. The brightness signal S determines the brightness of the display element, and corresponds to a brightness with which the display element actually emits light. Hereinafter, the brightness signal S is not distinguished from the brightness corresponding thereto, and the corresponding brightness is shown with the same symbol S.

An image signal input to the signal processing unit 11 is input to a comparison unit 13 so that a brightness level indicated by the input gray-scale signal Vin is compared to the first threshold brightness Ith1 for each clock, where the first threshold brightness Ith1 has already been provided in the comparison unit 13. The comparison result is output from the comparison unit 13 as one of the signals:
(1) with brightness lower than the first threshold brightness Ith1, the brightness corresponding to an input gray-scale signal Vin, and
(2) with brightness higher than the first threshold brightness Ith1, the brightness corresponding to the input gray-scale signal Vin. When the brightness corresponding to the input gray-scale signal Vin is equivalent to the first threshold brightness Ith1, the signal (1) or the signal (2) determined in advance as the comparison result in that case is output.

An output from the comparison unit 13 is input to a conversion unit 14 configured to convert the input image signal Vin into the brightness signal S with reference to the output from the comparison unit 13.

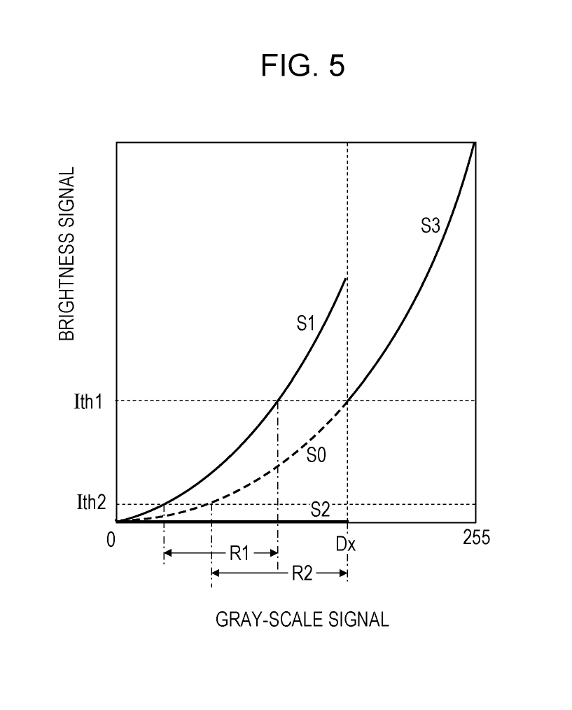

FIG. 5 is a graph illustrating the relationship between signals input to and output from the signal processing unit 11. The horizontal axis indicates an input gray-scale signal Vin and the vertical axis indicates the brightness signal S which is converted by the conversion unit 14 and output to the driving unit 15. The input gray-scale signal and the brightness signal S corresponding thereto on one-to-one basis are indicated by a broken line S0 illustrated in FIG. 5. Further, the symbol Dx indicates the gray scale at a point where the broken line S0 agrees with the first threshold brightness Ith1.

When the input gray-scale signal is not greater than the gray scale Dx, that is, a brightness indicated by the gray-scale signal is lower than the first threshold brightness Ith1, the comparison unit 13 outputs the signal (1) as the comparison result. Upon receiving the comparison result, the conversion unit 14 generates and outputs a first brightness signal S1 indicating a brightness which is twice as high as the brightness S0 corresponding to the input gray-scale signal Vin to the driving unit 15. Since the brightness S0 of the input gray-scale signal Vin has already been determined, the information of the brightness S0 is stored in the conversion unit 14. Upon receiving the gray-scale signal Vin, the information about the brightness S0 corresponding to the gray-scale signal Vin is read and multiplied by a coefficient 2 to calculate the first brightness signal S1. The driving unit 15 transmits a driving signal to an organic EL element of the display unit 12 based on the first brightness signal S1 to cause the organic EL element to emit light in the first half of a certain light-emission period.

Next, the conversion unit 14 generates and outputs a second brightness signal S2 corresponding to the lowest bright level, that is, a black level, to the driving unit 15. Since the second brightness signal is a black-level brightness signal, the driving unit 15 causes the organic EL element to stop emitting light in the latter half of the light-emission period.

The brightness signals S1 and S2 are set such that the average value thereof becomes equivalent to the brightness S0 corresponding to the original gray-scale signal. A brightness obtained as a time average of the entire light-emission period including the first-half light-emission period and the latter-half light-emission period agrees with the brightness of the original input signal.

When the brightness S0 indicated by the input image signal Vin is higher than the first threshold brightness Ith1, the conversion unit 14 generates a third brightness signal S3 equivalent to the brightness S0 of the input image signal Vin. Then, the conversion unit 14 outputs the third brightness signal S3 to the driving unit 15 in both the first half and the latter half of a certain time period. The driving unit 15 causes an organic EL element to emit light with the brightness corresponding to the same third brightness signal S3 in both the first half and the latter half of the certain light-emission period.

The conversion unit 14 generates the brightness signal S1 and the brightness signal S2 or the brightness signal S3 based on the gray-scale signal Vin. Then, the conversion unit 14 transmits the brightness signal S1 or the brightness signal S3 to be used in the first-half period of a single frame to the driving unit 15. Information about the other brightness signal S2 is temporarily stored in a memory 16, read in the latter-half period of the single frame, and transmitted to the driving unit 15. When the third brightness signal S3 is generated, the information thereof is also stored in the memory 16.

In the above-described example, the gray scale Dx to which the input gray-scale signal is compared is selected so that the brightness corresponding thereto agrees with the first threshold brightness Ith1. According to an embodiment of the invention, when the brightness corresponding to the input gray-scale signal falls within a brightness range where the striped unevenness is visually recognizable, that is, the region between the Ith1 and Ith2 that are illustrated in FIG. 5, the high-brightness display and the low-brightness display are performed during two separate time periods so that the striped unevenness becomes less visible. When defining a brightness range larger than the range where the striped unevenness is visually recognizable and separating a gray-scale signal into two brightness signals when the gray-scale signal falls within the larger brightness range, the effect of making the striped unevenness less visible is also achieved. Accordingly, the gray scale Dx may be selected from the gray-scale levels corresponding to brightness higher than the first threshold brightness Ith1 (and lower than the maximum brightness), that is, gray-scale levels falling within the region between the Dx and the numeral 255 that are illustrated in FIG. 5.

Output from the comparison unit 13 may be stored in the memory 16 in place of the brightness signal S2. The memory 16 stores the information on the comparison result (1) or (2) output from the comparison unit 13 as 1-bit information expressed as 0 and 1 in order of input image signals. The stored information is read in the same order as that in which the stored information was written, which means that the memory 16 is a FIFO (first-in, first-out) memory.

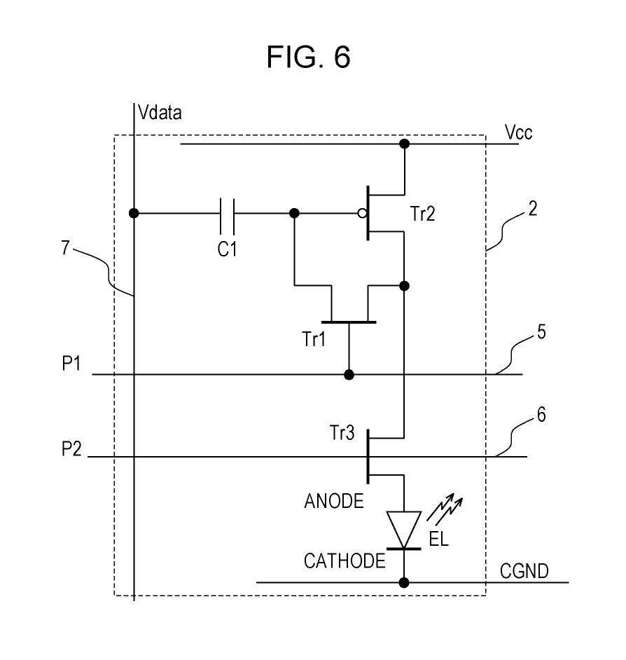

FIG. 6 illustrates a driving circuit 2 configured to drive an organic EL element of the display unit 12. The driving circuit 2 is provided for each of the organic EL elements EL, and a current is supplied from a power supply VCC to the organic EL element EL via a driving transistor Tr2 and a light-emission period control switch Tr3. The driving circuit 2 receives a data signal Vdata transferred to a data line 7 extending in the column direction, and accumulates the data signal Vdata in a holding capacitor C1, and the driving transistor Tr2 converts the accumulated data signal Vdata into a current. The driving circuits 2 are controlled in rows with two control lines 5(P1) and 6(P2) extending in the row direction.

The control line 5 (P1) controls turning on/off of a switch Tr1 causing a short circuit between the gate and the drain of the driving transistor Tr2. The control line 6 (P2) controls turning on/off of the light-emission period control switch Tr3. When the short-circuit switch Tr1 is turned on by the control line 5 (P1) and the light-emission period control switch Tr3 is turned off by the control line 6 (P2), a data voltage Vdata of the data line 7 is held as the voltage across the holding capacitor Cl. Thus, the data signal is written into the driving circuit 2.

After the data signal is written into each row, the voltage of the data line 7 becomes a certain potential lower than the data-signal potential at the same time as the time the light-emission period control switch Tr3 of each row is turned on. As a consequence, the gate-source voltage of the driving transistor Tr2 exceeds the threshold voltage of the driving transistor Tr2 and a current flows from the drain of the driving transistor Tr2 toward the organic EL element.

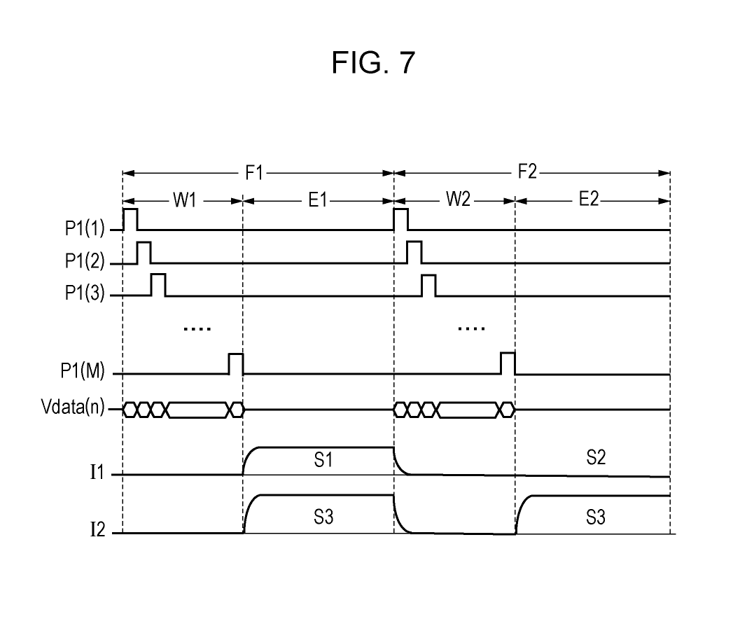

FIG. 7 is a timing chart illustrating the operation of the driving unit 15. From the top of the chart, illustrated are the signals of the control lines P1 of a first row, a second row, . . . , and an m-th row, a signal Vdata(n) of the data line of an n-th column, a brightness I1 of an organic EL element L1 to which a gray-scale signal with a brightness which is not greater than the first threshold brightness Ith1 is written, and a brightness 12 of an organic EL element L2 to which a gray-scale signal with a brightness higher than the first threshold brightness Ith1 is written. The horizontal axis indicates the time and indicates consecutive first and second periods F1 and F2. The first period F1 includes a writing period W1 and a light-emission period E1, and the second period F2 includes a writing period W2 and a light-emission period E2.

The image signal Vin is input in a cycle of a single frame period. The driving unit 15 selects organic EL elements in rows by the control lines P1 during the first writing period W1 of the first period F1, transmits the data signal Vdata corresponding to a brightness signal to the data line, and writes the brightness signal in the driving circuit of an organic EL element provided on the row. After the data signal is written into each row, the organic EL elements are caused to emit light during the light-emission period E1. The same operations are repeated during the second period F2.

The data signal Vdata corresponding to the first brightness signal S1 is written into the organic EL element L1. The gray-scale signal which is not greater than the gray scale Dx corresponding to the first threshold brightness Ith1 is input to the organic EL element L1 in the first writing period W1. The organic EL element L1 emits light with the corresponding brightness during the light-emission period E1. Subsequently, the data signal Vdata corresponding to the second brightness signal S2 is written into the organic EL element L1 during the second writing period W2. However, since the second brightness signal S2 is in the lowest brightness level, that is, the black level, the organic EL element L1 does not emit light during the second light-emission period E2.

In both the first and second writing periods W1 and W2, the third brightness signal S3 is written into the driving circuit of the organic EL element L2 where a gray-scale signal Vin is higher than the gray scale Dx, and the organic EL element L2 emits light with the brightness corresponding to the third brightness signal S3 in both the first and second light-emission periods E1 and E2.

According to the first embodiment, when the brightness of an input image signal is lower than the first threshold brightness Ith1, the organic EL element emits light with a brightness twice as high as the brightness of the input image signal over half the period, and does not emit light over the remaining half period. The uneven brightness is visually recognized if a brightness during the light-emission period E1 falls within a range between Ith2 and Ith1. However, the gray-scale range R1 corresponding to the brightness between Ith2 and Ith1 is smaller than the gray-scale range R2 where the input signal is converted to the original brightness S0. Accordingly, the frequency of occurrence of the uneven brightness is expected to decrease.

Further, when the brightness of an input image signal is higher than the first threshold brightness Ith1, light is emitted with the brightness S3=S0 indicated by the input signal. In that case, therefore, the brightness also becomes greater than the first threshold brightness.

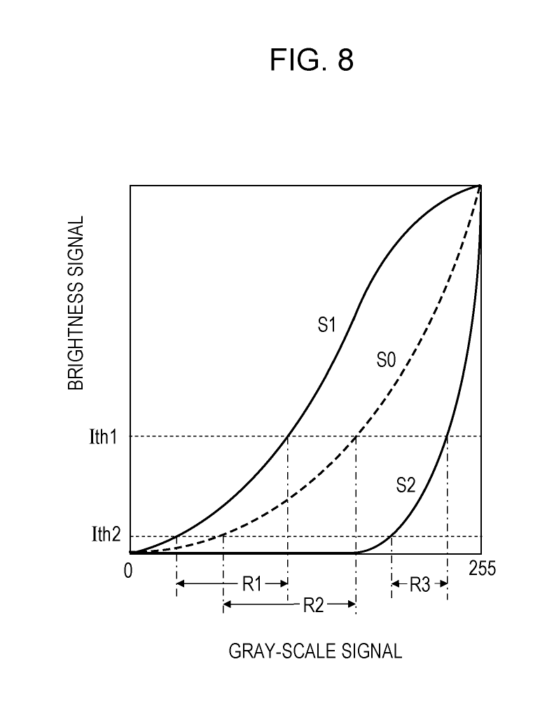

For comparison, an exemplary case where two different brightness signals are output for each input gray-scale signal will be described below. FIG. 8 illustrates the relationship between a gray-scale signal and a brightness signal, where data is displayed with two different brightnesses even though the brightness of an input image signal is higher than the first threshold brightness Ith1. The first brightness signal S1 higher than the input brightness S0 and the second brightness signal S2 lower than the input brightness S0 are generated, as well as the case where the brightness of the input image signal is lower than the first threshold brightness Ith1.

For a gray-scale signal larger than Dx, the second brightness signal S2 is not in the lowest brightness level. If the gray-scale is in the range denoted by R3 illustrated in FIG. 8, the brightness of the second brightness signal S2 falls within a range between Ith1 and Ith2, and the striped unevenness is visually recognized during the second light-emission period E2. The gray-scale signal range where the striped unevenness is visible in either the first light-emission period E1 or the second light-emission period E2 becomes the total of the ranges R1 and R3. On the contrary, the striped unevenness is visible for gray-signal in the range R1 in the present invention as shown in FIG. 5. Thus, using the two brightness signals in the whole gray-scale range increases the probability of visually recognizing the striped unevenness.

Since the light is emitted with different brightnesses when the brightness is low, and with single brightness when the brightness is high, the uneven brightness occurs only in the range R1.

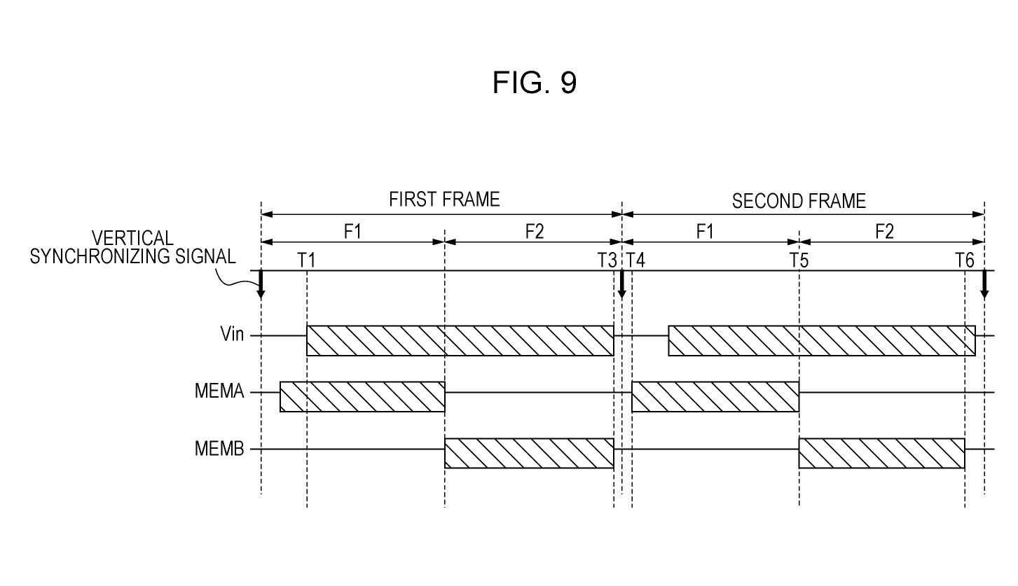

FIG. 9 illustrates the time when the memory 16 illustrated in FIG. 4 performs operations.

The memory 16 includes two memory regions MEMA and MEMB. The brightness signals S1 and S3 that are used to write data and emit light in the first half of a single frame are stored in the memory region MEMA, and the brightness signals S2 and S3 that are used to write data and emit light in the latter half of the single frame are stored in the memory region MEMB.

The image signals Vin are transmitted to the display apparatus in frames. The image signals Vin that are transmitted during a diagonally shaded period between the T1 and T3 of a first frame are converted into brightness signals S for each pixel by the conversion unit 14, and are written into the memory regions MEMA and MEMB in sequence. The above-described data is read from the memory region MEMA during a diagonally shaded period between T4 and T5 of the first period F1 of the next second frame, and transmitted to the driving unit 15. Subsequently, the data is read from the memory region MEMB during a diagonally shaded period shown between T5 and T6 of the second period F2.

In the memory region MEMB, “1” may be stored for the address of a pixel for which the brightness of an input gray-scale signal is determined to be lower than the first threshold brightness Ith1 by the comparison unit 13 and “0” may be stored for the address of a pixel other than the above-described pixel as data in place of the brightness signal S2. In that case, the memory region MEMA should have a capacity to store the data of all of pixels with the bit width of the gray-scale signal. However, since the memory region MEMB stores binary data represented as “0” and “1”, the memory region MEMB requires only a capacity to store the data corresponding to 1 bit×all pixels.

### Second Embodiment

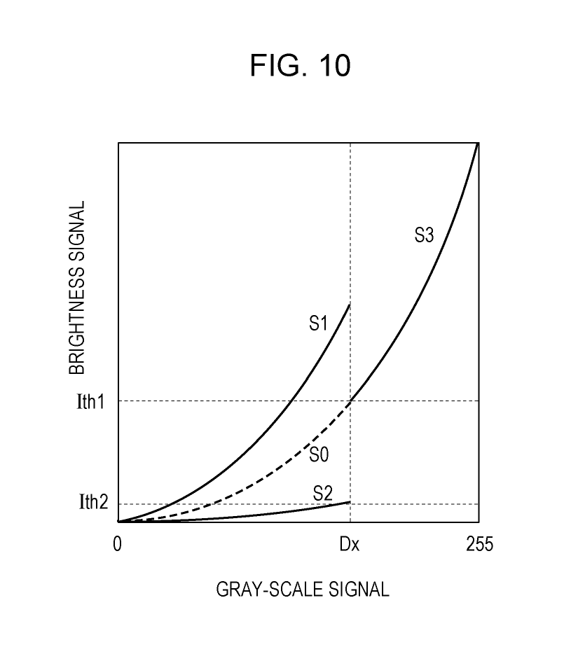

FIG. 10 illustrates the relationship between the gray-scale signal and the brightness signal of a display apparatus according to a second embodiment of the present invention. The same elements as those of FIG. 5 are shown with the same symbols and the descriptions thereof will be omitted. The general configuration of the display apparatus is the same as that shown in FIG. 4.

The second embodiment is different from the first embodiment in that the second brightness signal S2 is a brightness signal that is not in the lowest brightness (black) level and that is not zero based on an input gray-scale signal. Further, the second brightness signal S2 is written during the first writing period W1 of the first half of a single frame and light is emitted with the brightness of the second brightness signal S2 during the first light-emission period E1, and the first brightness signal S1 is written during the second writing period W2 of the latter half of the single frame and light is emitted with the brightness of the first brightness signal S1 during the second light-emission period E2.

The brightness signal S2 given in the first period causes the organic EL element to emit light with a brightness which is not greater than the second threshold brightness Ith2. Therefore, the striped unevenness is not visually recognized as is the case with the first embodiment. The brightness signal S2 given in the first period F1 and the brightness signal S1 given in the second period F2 are set so that the value of the average thereof becomes equivalent to the brightness S0 corresponding to the original input gray-scale signal as is the case with the first embodiment. The second brightness signal S2 is calculated by multiplying the brightness S0 by a positive coefficient smaller than 1, and the first brightness signal S1 is calculated by multiplying the brightness S0 by a coefficient which is smaller than 2 and larger than 1.

### Third Embodiment

In the first and second embodiments, the organic EL element is caused to emit light based on the brightness signal corresponding to a brightness higher than an input gray-scale signal during the first period which is the first half of a single frame period or the second period which is the latter half of the single frame period, and the organic EL element is caused to emit light based on the brightness signal corresponding to a brightness lower than the input gray-scale signal during the other period. In that case, the high-brightness display and the low-brightness display are alternately made in light-emission periods, which may cause image-screen flicker.

According to the third embodiment, the organic EL elements which emit light based on the high-brightness signal during a light-emission period and the organic EL elements which emit light based on the low-brightness signal during a light-emission period are provided in a mixed manner. For example, the organic EL elements are divided so that the organic EL elements adjacent to one another in vertical and horizontal directions are arranged in a checkered pattern, or the organic EL elements are alternately arranged in the row or column direction. As a result of averaged brightness of the adjacent organic EL elements, the flicker is reduced.

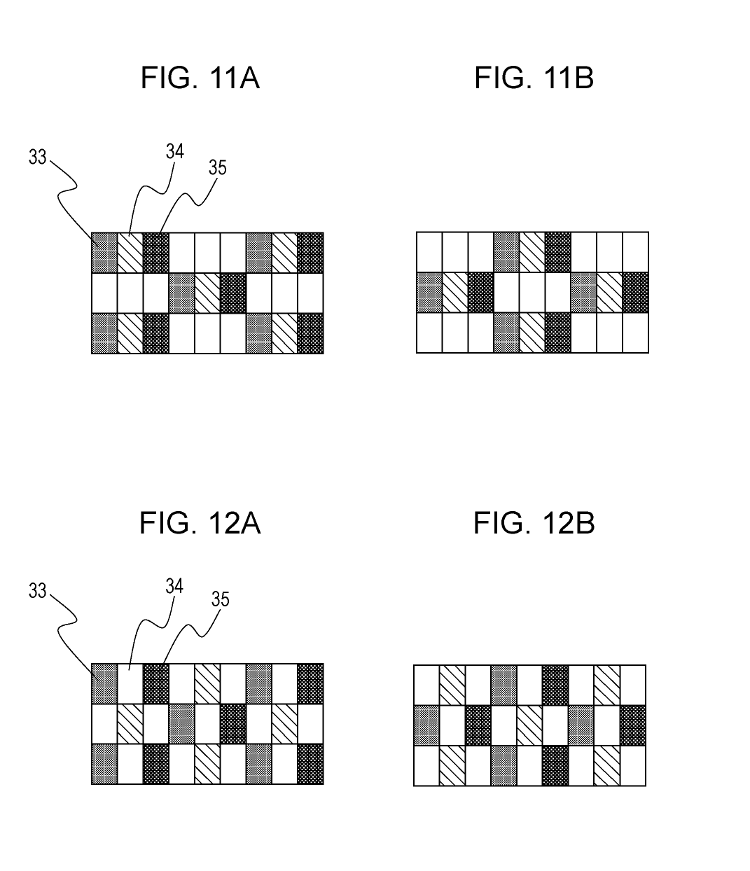

FIGS. 11A and 11B illustrate a light-emission sequence of the display apparatus according to the third embodiment. FIG. 11A illustrates the light emission in the first period corresponding to the first half of the frame and FIG. 11B illustrates the light emission in the second period corresponding to the latter half of the frame.

An organic EL element 33 emitting light of red (R) color, an organic EL element 34 emitting light of green (G) color, and an organic EL element 35 emitting light of blue (B) color are periodically arranged in the row direction, and the organic EL elements corresponding to the three colors are included in a single pixel. Light is emitted pixel by pixel based on the first brightness signal S1 (high-brightness signal) and the second brightness signal S2 (low-brightness signal) alternately, and the phases of the high-brightness light emission and the low-brightness light emission of the adjacent pixels are opposite to each other.

FIGS. 12A and 12B illustrate a light-emission sequence when light is not emitted pixel by pixel, but is emitted by the organic EL elements 33, 34, and 35 arranged in a checkered pattern with reversing their phases.

### Fourth Embodiment

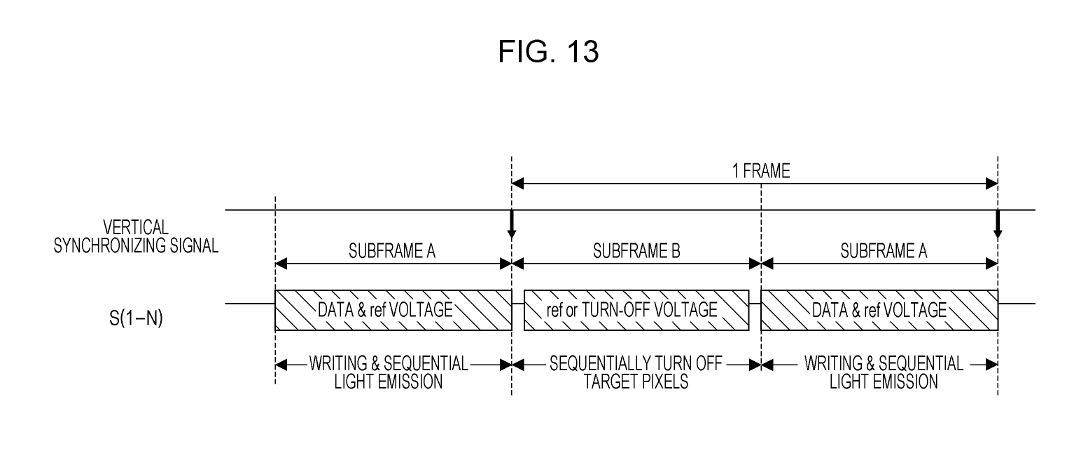

FIG. 13 illustrates a fourth embodiment of the present invention. According to the fourth embodiment, the light emission of the first period, the light emission being performed with a brightness twice as high as an ordinary brightness, and the light-emission suspension of the second period are sequentially performed in a row.

A single frame is halved into subframes A and B. In the subframe A, programming is performed for each row. When the programming is shifted from one row to the next row, the operation is switched to a light-emission operation in sequence. After finishing the programming for each row, the programming is immediately shifted to the subframe B where programming is performed to suspend the light emission for a pixel programmed with a data signal in the subframe A.

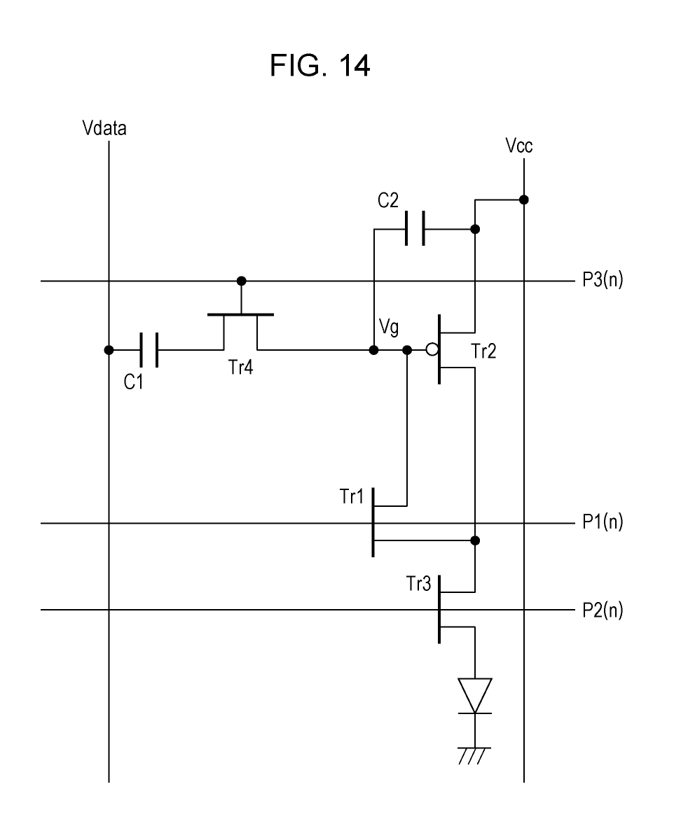

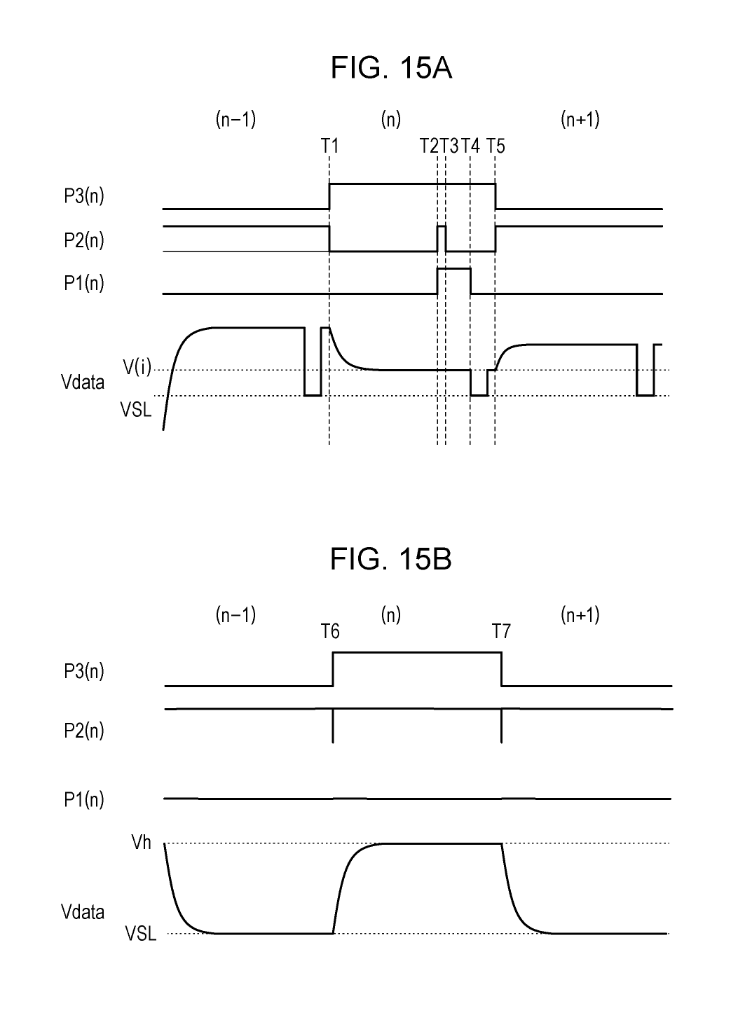

FIG. 14 illustrates a driving circuit according to the fourth embodiment, and FIGS. 15A and 15B are timing charts illustrating the operations thereof.

The driving circuit illustrated in FIG. 14 is equivalent to that shown in FIG. 6 except that a transistor Tr4 is provided between the holding capacitor C1 and the driving transistor Tr2, and a capacitor C2 is provided between the power supply VCC and the driving transistor Tr2.

FIG. 15A illustrates a programming operation for a pixel provided on the n-th row of the subframe A. The data line is set to the data signal Vdata for programming during a period between T1 and T2. The threshold value of the driving transistor Tr2 in a pixel circuit is cancelled during a period between T2 and T3, and image data V(i) is written into the pixel at the same time. When a pre-charge operation is performed during the period between T2 and T3, a current passes through the organic EL element irrespective of image data and light is momentarily emitted. However, the gray-scale display is not affected by the light emission.

During the period between T3 and T4, the threshold values are cancelled and the image data is written in pixels on the rows following the n-th row. During the period between T4 and T5, a voltage VSL is applied to a signal line and the current corresponding to the current-driving capacity of the transistor Tr2 is supplied to the organic EL elements of pixels on the row so that the light-emission operation is started. From the time T5 onward, a voltage obtained by decreasing the threshold reset voltage of the transistor Tr2, which is accumulated in the capacitor C2, by a differential voltage V(i)−VSL is maintained.

Next, the second brightness signal S2 (black level) corresponding to the pixel where the light emission is suspended is written on each of rows in sequence in the subframe B, as illustrated in FIG. 15B. During the period between T6 and T7, the potential of the data line Vdata is written into the capacitor C2 via the capacitor C1 when a signal P3(n) turns to a high level and the light-emission period control switch Tr3 is turned on. At that time, the data-line potential is Vh, which is set to a potential satisfying the inequality:

Vh−VSL>V(i)max−VSL,

where V(i) denotes the maximum value of output-video data V_out.

In a pixel emitting light in response to the value V(i) written therein in the period of the subframe A, the gate potential of the transistor Tr2 is increased by a potential Vh−VSL and the gate-source potential of the transistor Tr2 is reduced to 0 or below. Therefore, the operation of the pixel is switched to the turn-off operation. When the data line Vdata has the voltage VSL, the voltage of the pixel emitting light in response to the value V(i) written therein in the period of the subframe A is held, as it is, so that the pixel continues the light-emission operation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-277320 filed Dec. 13, 2010, which is hereby incorporated by reference herein in its entirety.

What is claimed is:

1. A display apparatus comprising: a display unit having an array of light emitting elements; a driving unit that drives and causes the light emitting elements to emit light; and a signal processing unit that processes and transfers an input image signal to the driving unit,
the signal processing unit including a comparison unit configured to compare a gray-scale signal included in the image signal to a certain gray-scale level and a conversion unit configured to convert the gray-scale signal into a brightness signal,
wherein when the comparison unit outputs a result indicating that the gray-scale signal in the image signal is lower than the certain gray-scale level, the conversion unit generates a first brightness signal that gives a brightness higher than the brightness given based on the gray-scale signal and a second brightness signal that gives a brightness lower than the brightness given based on the gray-scale signal, and the driving unit causes the light emitting element to emit light in accordance with the first and second brightness signals during a former and a latter half of a light-emission period, and
wherein when the comparison unit outputs a result indicating that the gray-scale signal in the image signal is higher than the certain gray-scale level, the conversion unit converts the gray-scale signal into a third brightness signal corresponding to a brightness given based on the gray-scale signal, and the driving unit causes the light emitting element to emit light in accordance with the third brightness signal during both of the former and the latter half of the light-emission period.

2. The display apparatus according to claim 1, wherein the brightness corresponding to the certain gray-scale level is a brightness of an upper limit of a brightness range where uneven brightness is visually recognized, or a brightness between the upper limit and a maximum brightness.

3. The display apparatus according to claim 1, wherein the second brightness signal is a brightness signal corresponding to a lowest brightness of the light emitting element.

4. The display apparatus according to claim 3, further comprising a memory configured to store 1 bit data on the result outputted by the comparison unit.

5. The display apparatus according to claim 1, wherein the second brightness signal is a brightness signal obtained between a lowest brightness of the light emitting element and a lower limit of a brightness range where uneven brightness is visually recognized.

6. The display apparatus according to claim 1, wherein two adjacent light emitting elements emit light during the former and the latter half of the light-emission period in accordance with the first and second brightness signals, the two light emitting elements receiving the first and second brightness signals in mutually opposite order.

7. The display apparatus according to claim 1, wherein the array of light emitting elements includes an array of pixels, each of the pixels including at least two light emitting elements of different colors, and wherein two light emitting elements of a same color in adjacent pixels emit light in accordance with the first and second brightness signals during the former and the latter half of the light-emission period, the two light emitting elements receiving the first and second brightness signals in mutually opposite order.
